(19) United States
(12) Patent Application Publication
(10) Pub. No.: US 2025/0150961 A1
(43) Pub. Date: May 8, 2025

(54) ELECTRONIC APPARATUS, CONTROL METHOD OF ELECTRONIC APPARATUS, AND NON-TRANSITORY COMPUTER-READABLE STORAGE MEDIUM STORING PROGRAM

(71) Applicant: CANON KABUSHIKI KAISHA, Tokyo (JP)

(72) Inventor: KOJI OKAMURA, Kanagawa (JP)

(21) Appl. No.: 18/940,972

(22) Filed: Nov. 8, 2024

(30) Foreign Application Priority Data
Nov. 8, 2023 (JP) 2023-191129

(51) Int. Cl. H04W 48/20; H04W 84/12

(52) U.S. Cl. CPC H04W 48/20; H04W 84/12

(57) ABSTRACT

An apparatus communicable with an external access point (AP), including: a first change unit to change, based on the reception of a first change request, the connection destination of the apparatus to a second AP included in at least one AP corresponding to information included in the first change request; a first determination unit to determine, based on the information concerning the first AP stored in a memory before a second change request is received, whether the first AP is included in at least one AP corresponding to information included in the second change request; and a second change unit to change the connection destination of the apparatus to the first AP based on determination that the first AP is included in the at least one AP corresponding to the information included in the second change request.

### BACKGROUND OF THE INVENTION

### Field of the Invention

The present invention relates to an electronic apparatus connectable by a wireless LAN, a control method of the electronic apparatus, and a non-transitory computer-readable storage medium storing a program.

### Description of the Related Art

There is a technique of dynamically switching a connection destination AP in order to efficiently exchange data between an Access Point (AP) and a Station (STA) in an Extended Service Set (ESS) constituted by a plurality of APs. If it is determined to switch the connection destination AP based on the degree of congestion of an AP to which an STA is connected, the availability of other APs, the radio wave status, and the like, the connected AP transmits a connection AP change request to the STA. Upon receiving the AP change request, the STA can switch the connection destination AP in accordance with the request and can be connected to a proper AP.

Japanese Patent Laid-Open No. 2021-175068 discloses the following processing as processing of requesting, from a router having an AP function, a connected wireless slave device to change a connection destination. A mobile router (MR1) connectable to a plurality of wireless slave devices confirms whether a wireless slave terminal complies with IEEE 802.11v. Whether a wireless slave terminal complies with IEEE 802.11v can be determined from an Association Request frame transmitted when the wireless slave terminal is wirelessly connected to the MR1. When the wireless slave terminal complies with IEEE 802.11v, the MR1 transmits a BSS Transition Management (BTM) Request frame to the wireless slave terminal. The BSS Transition Candidate List Entries field of the BTM Request frame designates the BSSID of a master router RT2 as a connection destination. This prompts switching of the connection destination of the wireless slave terminal, and the wireless slave terminal switches the connection destination from the MR1 to the RT2 in accordance with the received BTM Request frame.

### SUMMARY OF THE INVENTION

The present invention provides an electronic apparatus that can control change of a connection destination AP in a case where an access point decided by a user setting is changed to another access point, a control method of the electronic apparatus, and a non-transitory computer-readable storage medium storing a program.

The present invention in one aspect provides an electronic apparatus communicable with an external access point, the electronic apparatus comprising at least one memory and at least one processor which function as: a connection unit configured to establish connection between a first access point and the electronic apparatus; a storage unit configured to store information concerning the first access point in a memory; a first reception unit configured to receive, from the first access point, a first change request to request change of a connection destination of the electronic apparatus; a first change unit configured to change, based on the reception of the first change request, the connection destination of the electronic apparatus to a second access point included in at least one access point corresponding to information included in the first change request; a second reception unit configured to receive, from the second access point, a second change request to request change of the connection destination of the electronic apparatus after changing the connection destination of the electronic apparatus to the second access point; a first determination unit configured to determine, based on the information concerning the first access point stored in the memory before the second change request is received, whether the first access point is included in at least one access point corresponding to information included in the second change request; and a second change unit configured to change the connection destination of the electronic apparatus to the first access point based on determination that the first access point is included in the at least one access point corresponding to the information included in the second change request.

According to the present invention, it is possible to control change of a connection destination AP in a case where an access point decided by a user setting is changed to another access point.

Further features of the present invention will become apparent from the following description of exemplary embodiments with reference to the attached drawings.

### BRIEF DESCRIPTION OF THE DRAWINGS

FIG. 1 is a view showing a system configuration;

FIGS. 2A and 2B are views showing the arrangement of an MFP;

FIGS. 3A, 3B, and 3C are views showing the operation display unit of the MFP;

FIGS. 4A and 4B are views showing the arrangement of a mobile terminal apparatus;

FIG. 5 is a block diagram showing the arrangement of an access point;

FIG. 6 is a sequence chart for explaining processing corresponding to a connection destination change request from an AP;

FIG. 7 is a flowchart illustrating processing in the MFP;

FIG. 8 is a flowchart illustrating processing in the MFP; and

FIG. 9 is a flowchart illustrating processing in the MFP.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

When the above-described STA is connected to an AP decided by a user setting, and then receives a connection destination AP change request from the AP, the STA automatically changes the connection destination to another AP. In this case, the STA remains connected to the AP that is not the AP decided by the user setting unless a connection destination AP change request is received again.

According to one aspect of the present invention, it is possible to control change of a connection destination AP in a case where an access point decided by a user setting is changed to another access point.

### First Embodiment

### (System Configuration)

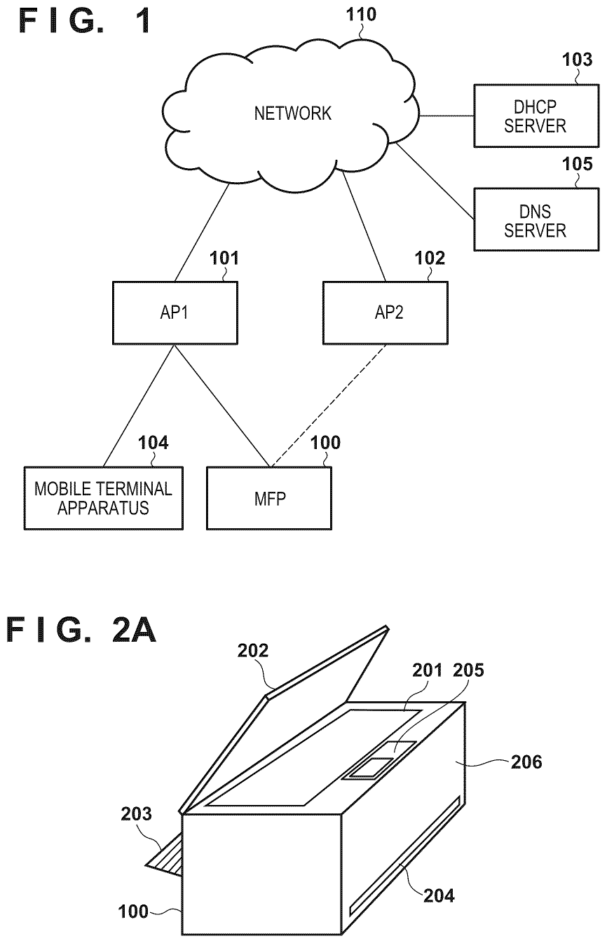

FIG. 1 shows an example of the configuration of a system according to this embodiment. In an example, the system is a wireless communication system in which a plurality of communication apparatuses can communicate with each other wirelessly. In the example of FIG. 1, the system includes a mobile terminal apparatus 104 and an MFP 100 as communication apparatuses, APs 101 and 102 as access points, a DHCP server 103, a DNS server 105, and a network 110. Note that the APs 101 and 102 are sometimes referred to as AP1 and AP2. The mobile terminal apparatus 104 is an apparatus having a wireless communication function by a wireless LAN or the like. Note that the wireless LAN will sometimes be referred to as WLAN hereinafter. The mobile terminal apparatus 104 can be a personal information terminal such as a Personal Digital Assistant (PDA), a mobile phone (smartphone), a digital camera, a personal computer, or the like.

The MFP 100 is a printing apparatus having a printing function, and may further have a reading function (scanner), a FAX function, and a telephone function. The MFP 100 according to this embodiment has a communication function capable of wirelessly communicating with the mobile terminal apparatus 104. A case where the MFP 100 is used will be exemplified in this embodiment, but the present invention is not limited to this. For example, a scanner, a projector, a mobile terminal, a smartphone, a notebook PC, a tablet terminal, a PDA, a digital camera, a music player, a television, or a smart speaker having a communication function may be used instead of the MFP 100. Note that the MFP is an acronym for Multi Function Peripheral.

The AP 101 is provided separately from (outside) the mobile terminal apparatus 104 and the MFP 100, and operates as a WLAN base station apparatus. A communication apparatus having a WLAN communication function can communicate in a WLAN infrastructure mode via the AP 101. Note that the access point will sometimes be referred to as “AP” hereinafter. The infrastructure mode will sometimes be referred to as “wireless infrastructure mode” hereinafter. The AP 101 performs wireless communication with a communication apparatus for which the AP 101 permits (authenticates) connection to the AP 101, and relays wireless communication between the communication apparatus and another communication apparatus. The AP 101 is connected to, for example, a wired communication network, and can relay communication between a communication apparatus connected to the wired communication network and another communication apparatus wirelessly connected to the AP 101.

The AP 102 has a function equivalent to that of the AP 101, and the MFP 100 switches the connection from the AP 101 to the AP 102, as needed. The DHCP server 103 is connected to the MFP 100 via the AP 101 and the network 110, and provides services to the MFP 100 in response to a request from the MFP 100. Note that it has been described with reference to FIG. 1 that the DHCP server 103 is configured to be connected as an apparatus separately from the APs 101 and 102 but the AP 101 or 102 may be configured to have a DHCP server function. The DNS server 105 is connected to the MFP 100 or the mobile terminal apparatus 104 via the AP 101 and the network 110, and provides a service for solving a name by responding to a request from the MFP 100 or the mobile terminal apparatus 104. The network 110 may be the so-called Internet, or a closed office network or a mobile phone network.

### (Outer Appearance Arrangement of MFP)

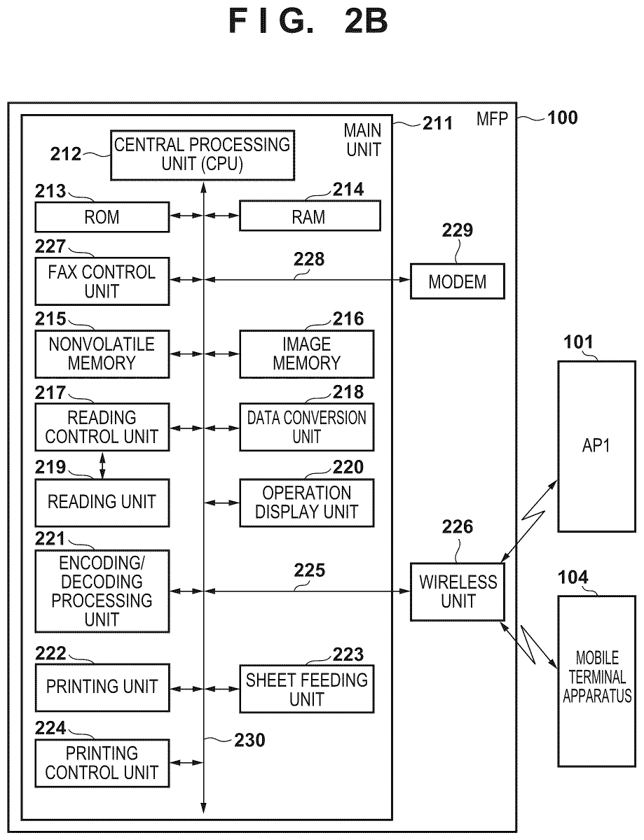

FIG. 2A shows an example of the outer appearance arrangement of the MFP 100. The MFP 100 includes, for example, a document table 201, a document cover 202, a print sheet insertion port 203, a print sheet discharge port 204, and an operation display unit 205. The document table 201 is a table on which a document to be read is placed. The document cover 202 is a cover that presses a document on the document table 201 and prevents outward leakage of light from a light source irradiating the document at the time of reading. The print sheet insertion port 203 is an insertion port at which sheets of various sizes can be set. The print sheet discharge port 204 is a discharge port from which a sheet upon printing is discharged. Sheets set at the print sheet insertion port 203 are conveyed one by one to a printing unit, and after printing by the printing unit, discharged from the print sheet discharge port 204. The operation display unit 205 includes keys such as character input keys, cursor keys, an OK key, and a cancel key, an LED, and an LCD, and is configured to be able to accept activation of various functions of the MFP and an operation of various settings by the user. The operation display unit 205 may include a touch panel display. The MFP 100 has a WLAN wireless communication function, and includes a wireless communication antenna 206 for the wireless communication that need not always be visible from the outer appearance. Similar to the mobile terminal apparatus 104, the MFP 100 can perform wireless communication in the 2.4- and 5-GHz frequency bands by the WLAN.

### (Arrangement of MFP)

FIG. 2B shows an example of the arrangement of the MFP 100. The MFP 100 includes a main unit 211 that performs main control of the MFP 100, and a wireless unit 226 serving as one communication module that performs WLAN communication using at least one common antenna. The MFP 100 also includes a modem 229 for performing, for example, wired communication. The main unit 211 is simply a unit that includes functional blocks other than the wireless unit 226 and the modem 229. The main unit 211 includes, for example, a central processing unit (CPU) 212, a ROM 213, a RAM 214, a nonvolatile memory 215, an image memory 216, a reading control unit 217, a data conversion unit 218, a reading unit 219, and an encoding/decoding processing unit 221. The main unit 211 includes, for example, a printing unit 222, a sheet feeding unit 223, a printing control unit 224, and an operation display unit 220. The functional units in the main unit 211 are connected to each other via a system bus 230 managed by the CPU 212. The main unit 211 and the wireless unit 226 are connected via, for example, a dedicated bus 225, and the main unit 211 and the modem 229 are connected via, for example, a bus 228.

The CPU 212 is a system control unit including at least one processor, and controls the overall MFP 100. In an example, processing of the MFP 100 to be described below is implemented by executing a program stored in the ROM 213 by the CPU 212. Note that hardware dedicated to each processing may be prepared. The ROM 213 stores control programs to be executed by the CPU 212, an embedded OS program, and the like. In the embodiment, the CPU 212 executes each control program stored in the ROM 213 under the management of the embedded OS similarly stored in the ROM 213, thereby performing software control such as scheduling or task switching.

The RAM 214 is constituted by an SRAM or the like. The RAM 214 stores data such as program control variables, and data such as set values registered by the user and management data of the MFP 100. The RAM 214 can be used as various work buffers. The nonvolatile memory 215 is constituted by a memory such as a flash memory, and keeps storing data even after the MFP 100 is turned off. The image memory 216 is constituted by a memory such as a DRAM. The image memory 216 accumulates image data received via the wireless unit 226, image data processed by the encoding/decoding processing unit 221, and the like. Note that the memory configuration of the MFP 100 is not limited to the above-described one. The data conversion unit 218 performs analysis of data of various forms, conversion from image data into print data, and the like.

The reading control unit 217 controls the reading unit 219 (for example, a contact image sensor (CIS)) to optically read a document on the document table 201. The reading control unit 217 converts an image obtained by optically reading the document into electrical image data (image signal), and outputs the image data. At this time, the reading control unit 217 may output image data after performing various image processes such as binarization processing and halftone processing.

The operation display unit 220 is the operation display unit 205 described with reference to FIG. 2A, and executes display on a display based on display control by the CPU 212, generation of a signal in response to acceptance of a user operation, and the like.

The encoding/decoding processing unit 221 performs encoding processing, decoding processing, and scaling processing on image data (JPEG, PNG, and the like) handled by the MFP 100. The sheet feeding unit 223 holds sheets for printing. The sheet feeding unit 223 can supply a set sheet under the control of the printing control unit 224. The sheet feeding unit 223 may include a plurality of sheet feeding units in order to hold sheets of a plurality of types in one apparatus, and can control which sheet feeding unit feeds a sheet under the control of the printing control unit 224.

The printing control unit 224 performs various image processes such as smoothing processing, print density correction processing, and color correction on image data to be printed, and outputs the processed image data to the printing unit 222. The printing unit 222 is configured to be able to execute printing processing by, for example, the inkjet printing method, and discharges, from a printhead, ink supplied from an ink tank to print an image on a print medium such as a sheet. Note that the printing unit 222 may be configured to be able to execute another printing processing by the electrophotographic method or the like. The printing control unit 224 can periodically read out information of the printing unit 222, and update status information and the like that are stored in the RAM 214 and include the remaining amount of the ink tank and the state of the printhead.

The wireless unit 226 is a unit capable of providing the WLAN communication function, and can provide, for example, a function similar to a combination of a WLAN unit 429 of the mobile terminal apparatus 104. That is, the wireless unit 226 converts data into a packet in accordance with the WLAN standard, and transmits the packet to another device. In addition, the wireless unit 226 restores original data from a packet from another external device, and outputs the data to the CPU 212. The wireless unit 226 can communicate as a station complying with the IEEE 802.11 standard series. In particular, the wireless unit 226 can communicate as a station complying with IEEE 802.11a/b/g/n/ac/ax. The station will sometimes be referred to as the STA hereinafter. The wireless unit 226 can also communicate as an STA complying with Wi-Fi Agile Multiband™.

The wireless unit 226 complies with IEEE 802.11ax, that is, Wi-Fi 6™, and can perform processing complying with IEEE 802.11ax. That is, the MFP 100 can perform one or both of processing as an STA supporting (complying with) OFDMA and an operation (processing) as an STA supporting (complying with) TWT. OFDMA is an abbreviation for Orthogonal Frequency-Division Multiple Access. TWT is an abbreviation for Target Wake Time. Since the MFP 100 supports TWT, the timing of data communication from a master device to an STA is adjusted. The wireless unit 226 (MFP 100) as the STA shifts the communication function to a sleep state when it need not wait for signal reception. This can suppress power consumption. The wireless unit 226 also supports Wi-Fi 6E™. That is, the wireless unit 226 can communicate even in the 6-GHz band (5.925 GHz to 7.125 GHZ). A target band present in the 5-GHz band in which Dynamic Frequency Selection (DFS) is performed does not exist in the 6-GHz band. In the 6-GHz band communication, therefore, a communication disconnection caused by the DFS standby time does not occur, and more comfortable communication can be expected.

Note that the mobile terminal apparatus 104 and the MFP 100 can perform WFD-based P2P (WLAN) communication, and the wireless unit 226 has a software access point (software AP) function or a group owner function. That is, the wireless unit 226 can construct a P2P communication network and decide a channel to be used in P2P communication.

### (Operation Display Unit of MFP)

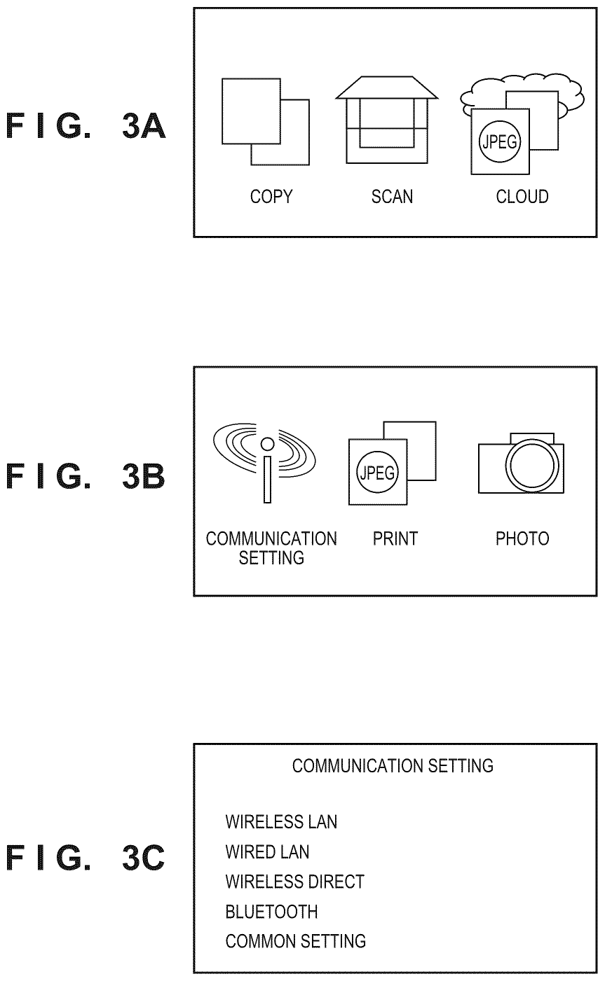

FIGS. 3A to 3C each schematically show an example of a screen display on a display (touch panel display) included in the operation display unit 220 of the MFP 100. FIG. 3A shows an example of a home screen displayed during a state (idle state or Standby state) in which the MFP 100 is turned on and an operation such as printing or scanning is not performed. In FIG. 3A, display items (menu items) corresponding to copy, scan, and cloud are displayed. Cloud is a menu item regarding a cloud function using Internet communication. When any menu item is selected by a key operation or a touch panel operation, the MFP 100 can start executing a corresponding setting or function. The MFP 100 can seamlessly display a screen different from one in FIG. 3A by accepting a key operation or a touch panel operation on the home screen in FIG. 3A.

FIG. 3B shows a display example of another portion of the home screen. This screen is shifted from the state in FIG. 3A by an operation (for example, a slide operation to left or right) of displaying another page of the home screen. In FIG. 3B, display items (menu items) corresponding to communication setting, print, and photo are displayed. When any menu item is selected, a function corresponding to the selected menu item, that is, any of the printing function, photo function, and communication setting is executed.

FIG. 3C shows a display example of the menu screen of the communication setting displayed when the communication setting is selected on the screen in FIG. 3B. The menu screen of the communication setting displays menu items (options) “wireless LAN”, “wired LAN”, “wireless direct”, “Bluetooth”, and “common setting”. “Wireless LAN”, “wired LAN”, and “wireless direct” are menu items for performing LAN setting. From these items, settings such as setting of wired connection, enable/disable setting of the wireless infrastructure mode, and enable/disable setting of the P2P mode such as WFD or software AP mode can be performed. When the item “wireless LAN” is selected and the wireless LAN is enabled by a user operation, the wireless infrastructure mode is enabled. When the item “wireless direct” is selected and the wireless direct is enabled by a user operation, the P2P (WLAN) mode is enabled. On this screen, a common setting menu regarding various connection forms is also displayed. The user can perform, from this screen, setting of the frequency band and frequency channel of the wireless LAN, and the like.

### (Outer Appearance Arrangement of Mobile Terminal Apparatus)

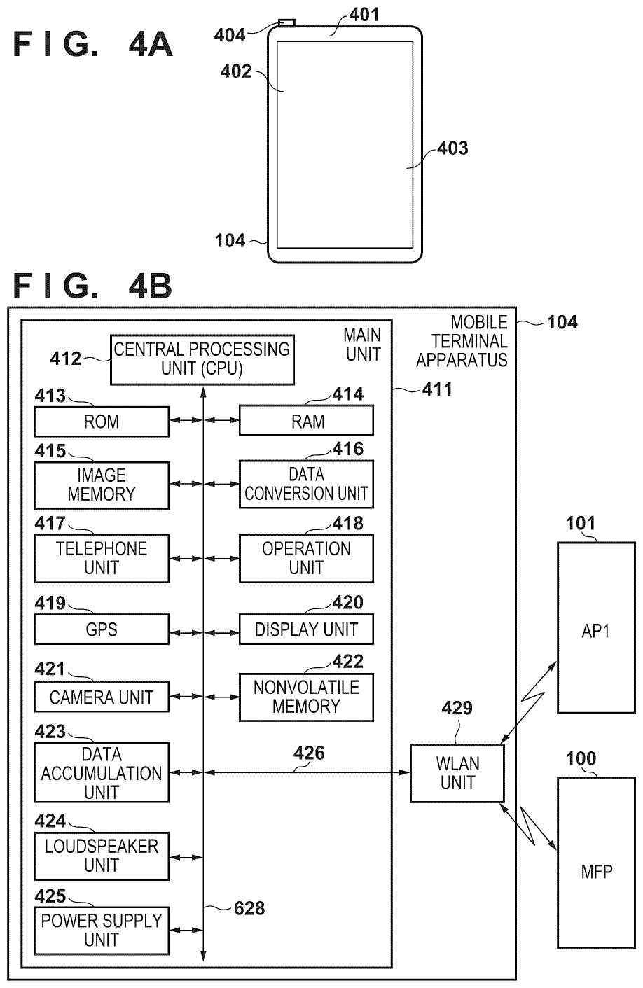

FIG. 4A is a view showing an example of the outer appearance arrangement of the mobile terminal apparatus 104. In this embodiment, a case where the mobile terminal apparatus 104 is a smartphone of a general form will be exemplified. Note that the mobile terminal apparatus 104 includes, for example, a display unit 402, an operation unit 403, and a power key 404. The display unit 402 is, for example, a display including a Liquid Crystal Display (LCD) type display mechanism. Note that the display unit 402 may display information using, for example, a Light Emitting Diode (LED) or the like. The mobile terminal apparatus 104 may have a function of outputting information by an audio, in addition to or instead of the display unit 402. The operation unit 403 includes hardware keys such as keys and buttons and a touch panel for detecting a user operation. Note that in this example, information display on the display unit 402 and acceptance of a user operation by the operation unit 403 are performed using a common touch panel display, and the display unit 402 and the operation unit 403 are implemented by one device. In this case, for example, button icons and a software keyboard are displayed using the display function of the display unit 402, and touches of these portions by the user are detected by the operation acceptance function of the operation unit 403. Note that it is also possible to separate the display unit 402 and the operation unit 403, and separately prepare display hardware and operation acceptance hardware. The power key 404 is a hardware key for accepting a user operation of turning on or off the mobile terminal apparatus 104.

The mobile terminal apparatus 104 includes a WLAN unit 401 that provides the WLAN communication function though it need not always be visible from the outer appearance. The WLAN unit 401 is configured to be able to execute data (packet) communication in a WLAN system complying with, for example, the IEEE 802.11 standard series (for example, IEEE 802.11a/b/g/n/ac/ax). The WLAN unit 401 can communicate as an AP complying with Wi-Fi Agile Multiband™. However, the WLAN unit 401 is not limited to this, and may be able to execute communication of a WLAN system complying with another standard. Note that this example assumes that the WLAN unit 401 can communicate in both the 2.4- and 5-GHz frequency bands. In addition, the WLAN unit 401 can execute WFD-based communication, communication in the software AP mode, communication in the wireless infrastructure mode, and the like. Operations in these modes will be described later.

### (Arrangement of Mobile Terminal Apparatus)

FIG. 4B shows an example of the arrangement of the mobile terminal apparatus 104. In an example, the mobile terminal apparatus 104 includes a main unit 411 that performs main control of the mobile terminal apparatus 104, and a WLAN unit 429 that performs WLAN communication. The main unit 411 is simply a unit that includes functional blocks other than the WLAN unit 429. The main unit 411 includes, for example, a CPU 412, a ROM 413, a RAM 414, an image memory 415, a data conversion unit 416, a telephone unit 417, a GPS 419, a camera unit 421, a nonvolatile memory 422, a data accumulation unit 423, a loudspeaker unit 424, and a power supply unit 425. The CPU is an acronym for Central Processing Unit, the ROM is an acronym for Read Only Memory, the RAM is an acronym for Random Access Memory, and the GPS is an acronym for Global Positioning System. The mobile terminal apparatus 104 also includes a display unit 420 and an operation unit 418. The functional units in the main unit 411 are connected to each other via a system bus 628 managed by the CPU 412. The main unit 411 and the WLAN unit 429 (the above-described WLAN unit 401) are connected via, for example, a dedicated bus 426.

The CPU 412 is a system control unit including at least one processor, and controls the overall mobile terminal apparatus 104. In an example, processing of the mobile terminal apparatus 104 to be described below is implemented by executing a program stored in the ROM 413 by the CPU 412. Note that hardware dedicated to each processing may be prepared. The ROM 413 stores control programs to be executed by the CPU 412, an embedded operating system (OS) program, and the like. In this embodiment, the CPU 412 executes each control program stored in the ROM 413 under the management of the embedded OS similarly stored in the ROM 413, thereby performing software control such as scheduling or task switching.

The RAM 414 is constituted by a Static RAM (SRAM) or the like. The RAM 414 stores data such as program control variables, and data such as set values registered by the user and management data of the mobile terminal apparatus 104. The RAM 414 can be used as various work buffers. The image memory 415 is constituted by a memory such as a Dynamic RAM (DRAM). The image memory 415 temporarily stores image data received via the WLAN unit 429 and image data read out from the data accumulation unit 423 so as to be processed by the CPU 412. The nonvolatile memory 422 is constituted by a memory such as a flash memory, and keeps storing data even after the mobile terminal apparatus 104 is turned off. Note that the memory configuration of the mobile terminal apparatus 104 is not limited to the above-described one. For example, the image memory 415 and the RAM 414 may be shared, or the data accumulation unit 423 may be used to perform backup of data or the like. The DRAM is exemplified as the image memory 415 in this embodiment, but another storage medium such as a hard disk or a nonvolatile memory may be used.

The data conversion unit 416 performs analysis of data of various forms, and data conversion such as color conversion or image conversion. The telephone unit 417 controls a telephone line, and processes audio data input/output via the loudspeaker unit 424, thereby implementing telephone communication. The GPS 419 receives radio waves sent from a satellite and acquires position information such as the current latitude and longitude of the mobile terminal apparatus 104.

The camera unit 421 has a function of electronically recording an image input via a lens and encoding it. Image data obtained by image capturing by the camera unit 421 is saved in the data accumulation unit 423. The loudspeaker unit 424 performs control for implementing a function of inputting or outputting a speech for the telephone function, and a function such as alarm notification. The power supply unit 425 is, for example, a portable battery and performs power supply control into the apparatus. The power supply state includes, for example, a battery dead state in which the battery runs out, a power-off state in which the power key 404 is not pressed, an active state in which the mobile terminal apparatus 104 is normally activated, and a power saving state in which the mobile terminal apparatus 104 is activated but power is saved.

The display unit 420 is the display unit 402 described with reference to FIG. 4A, and displays various input operations, the operation state and status condition of the mobile terminal apparatus 104, and the like based on the control of the CPU 412. The operation unit 418 is the operation unit 403 described with reference to FIG. 4A, and executes control of, upon accepting a user operation, generating an electrical signal corresponding to the operation and outputting it to the CPU 412.

The mobile terminal apparatus 104 performs wireless communication using the WLAN unit 429, and performs data communication with another device such as the MFP 100. The WLAN unit 429 converts data into a packet, and transmits the packet to another device. In addition, the WLAN unit 429 restores original data from a packet from another external device, and outputs the data to the CPU 412. The WLAN unit 429 is a unit for implementing communication complying with the WLAN standard. The WLAN unit 429 can operate concurrently in at least two communication modes including the wireless infrastructure mode and the P2P (WLAN) mode. Note that frequency bands used in these communication modes can be restricted by the hardware functions and performance.

### (Arrangement of Access Point)

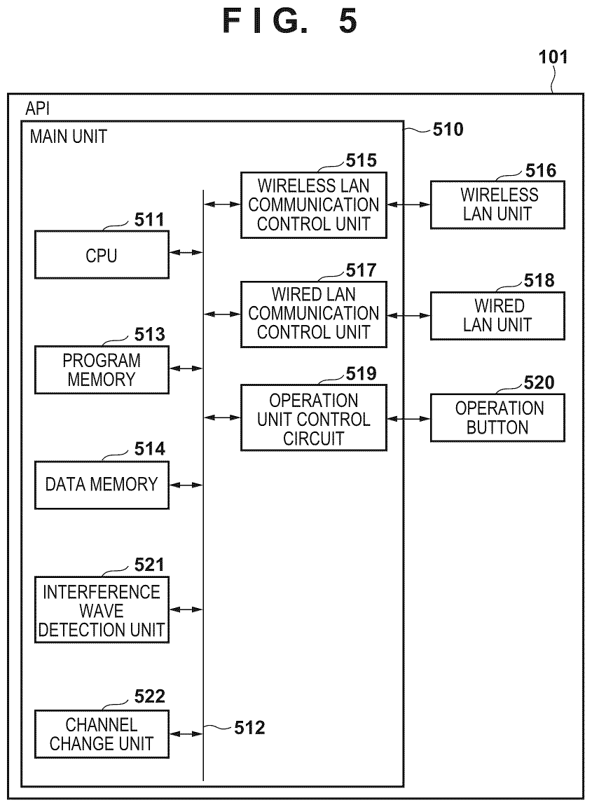

FIG. 5 is a block diagram showing the arrangement of the AP 101 having a wireless LAN access point function. The AP 101 includes a main unit 510 that controls the AP 101, a wireless LAN unit 516, a wired LAN unit 518, and an operation button 520. The main unit 510 is simply a unit that includes functional blocks other than the wireless LAN unit 516, the wired LAN unit 518, and the operation button 520.

A CPU 511 in the form of a microprocessor arranged on the main unit 510 operates in accordance with a control program stored in a program memory 513 in the form of a ROM connected via an internal bus 512, and data stored in a data memory 514 in the form of a RAM. The CPU 511 performs wireless LAN communication with another communication terminal apparatus by controlling the wireless LAN unit 516 via a wireless LAN communication control unit 515. The CPU 511 performs wired LAN communication with another communication terminal apparatus by controlling the wired LAN unit 518 via a wired LAN communication control unit 517. The CPU 511 can accept an operation from the user via the operation button 520 by controlling an operation unit control circuit 519. The CPU 511 includes at least one processor.

The AP 101 also includes an interference wave detection unit 521 and a channel change unit 522. The interference wave detection unit 521 performs interference wave detection processing when wireless communication is executed in a band in which Dynamic Frequency Selection (DFS) is executed. When an interference wave is detected while wireless communication is executed in the band in which DFS is executed, the channel change unit 522 performs change processing of a channel used in a case where the channel has to be immediately changed to a free channel.

Note that the AP 102 also has the same arrangement as that of the AP 101.

### (P2P Communication Method)

Next, a P2P (WLAN) communication method in which apparatuses wirelessly communicate with each other directly without intervention of an external access point in WLAN communication will be generally explained. P2P (WLAN) communication can be implemented using a plurality of methods. For example, a communication apparatus supports a plurality of modes for P2P (WLAN) communication, and can execute P2P communication (WLAN) by selectively using any one of these modes.

As the P2P mode, the following two modes are assumed:
software AP mode
Wi-Fi Direct (WFD) mode

A communication apparatus capable of executing P2P communication can be configured to support at least either of these modes. However, even a communication apparatus capable of executing P2P communication need not support all these modes, and may be configured to support only some of the modes.

A communication apparatus (for example, the mobile terminal apparatus 104) having a WFD communication function accepts a user operation via the operation unit, and invokes an application (in some cases, a dedicated application) for implementing the communication function. The communication apparatus can display a user interface (UI) screen provided by the application to prompt a user operation, and execute WFD communication based on a user operation accepted in response.
Software AP Mode

In the software AP mode, a communication apparatus (for example, the mobile terminal apparatus 104) operates as the role of a client that requests various services. The other communication apparatus (for example, the MFP 100) operates as a software AP capable of executing a WLAN AP function by software setting. Note that commands and parameters transmitted/received when establishing wireless connection between the client and the software AP suffice to be those defined by the Wi-Fi® standard, so a description thereof will be omitted here. The MFP 100 operating in the software AP mode decides, as a master station, a frequency band and a frequency channel. The MFP 100 can select which of 5 GHz and 2.4 GHz is used as a frequency band, and which frequency channel is used in the frequency band.
WFD Mode

The MFP 100 may be statically activated as a master station in the WFD mode (Autonomous Group Owner). In this case, GO Negotiation processing for deciding a role becomes unnecessary. In addition, in this case, the MFP 100 decides, as a master station, a frequency band and a frequency channel. The MFP 100 can select which of 5 GHz and 2.4 GHz is used as a frequency band, and which frequency channel is used in the frequency band.

### (Wireless Infrastructure Mode)

In the wireless infrastructure mode, communication apparatuses (for example, the mobile terminal apparatus 104 and the MFP 100) that communicate with each other are connected to an external AP (for example, the AP 101) that controls the overall network, and communication between the communication apparatuses is performed via the AP. In other words, communication between the communication apparatuses is performed via the network constructed by the external AP. Each of the mobile terminal apparatus 104 and the MFP 100 finds the AP 101, transmits a connection request to the AP 101, and is connected to the AP 101, thereby enabling communication in the wireless infrastructure mode between these communication apparatuses via the AP 101. Note that a plurality of communication apparatuses may be connected to separate APs. In this case, communication between the communication apparatuses becomes possible by transferring data between the APs. Commands and parameters transmitted/received in communication between communication apparatuses via an access point suffice to be those defined by the Wi-Fi® standard, so a description thereof will be omitted here. In this case, the AP 101 decides a frequency band and a frequency channel. The AP 101 can select which of 5 GHZ, 2.4 GHz, and 6 GHz is used as a frequency band, and which frequency channel is used in the frequency band.

(Processing Corresponding to Connection Destination Change Request from AP to STA)

The mobile terminal apparatus 104 and the MFP 100 comply with a function released to the public as Wi-Fi Agile Multiband™. Wi-Fi Agile Multiband is a function of enabling selection of an optimal environment in accordance with a situation in which a Wi-Fi network changes. More specifically, STAs such as the mobile terminal apparatus 104 and the MFP 100, and APs such as the AP 101 exchange information about a network environment using the IEEE 802.11 series communication standard. By this information exchange, when a network is congested, the AP can induce the STA (cause the STA to change the connection destination) to another AP, frequency band, channel, or in some cases, another cellular service.

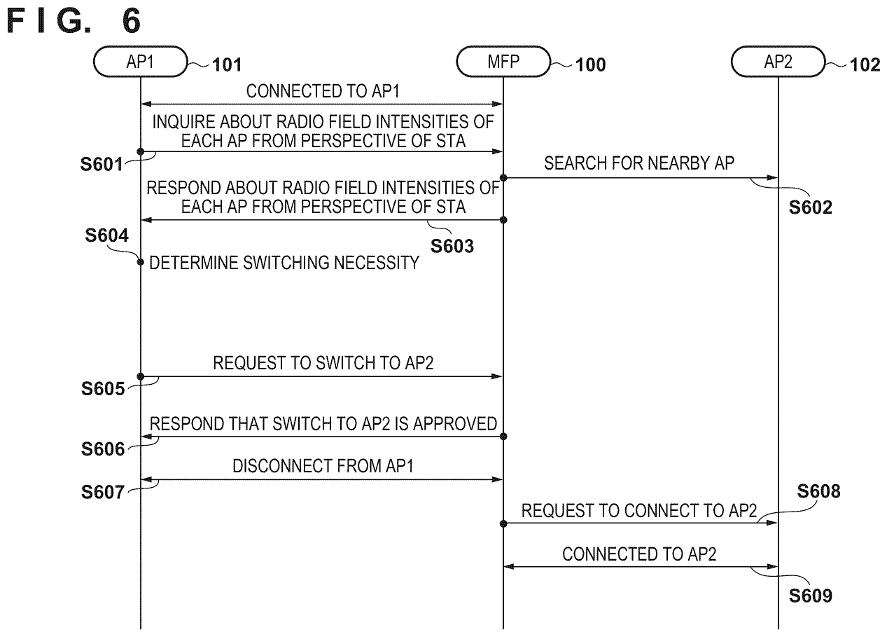

FIG. 6 is a sequence chart when the MFP 100 changes (switches) the connection destination AP from the AP 101 to the AP 102 in accordance with a connection destination change request from the AP 101. Note that in this specification, in other words, the change of the AP is switching of the AP. Processing executed by each apparatus in this sequence is implemented by reading out various programs stored in the memory of each apparatus such as a ROM to a RAM and executing them by the CPU of each apparatus.

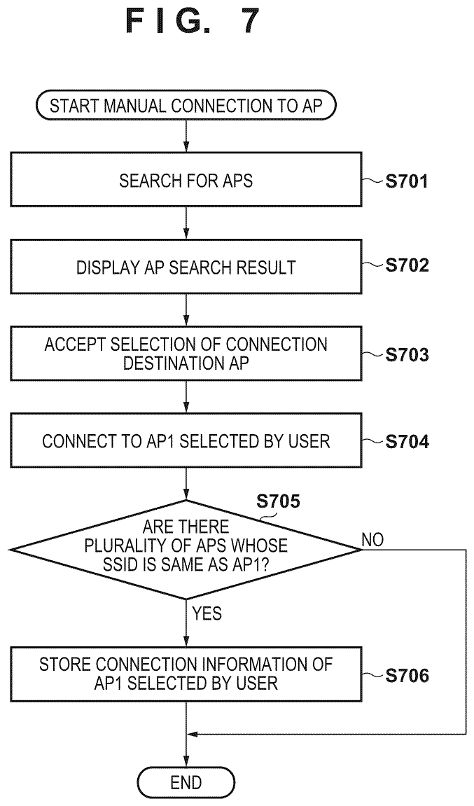

In the initial state of the processing in FIG. 6, assume that the MFP 100 establishes connection to the AP 101 in the wireless infrastructure mode. In this embodiment, the AP 101 is a user setting AP (to be described later), and connection between the MFP 100 and the AP 101 is established by processing shown in FIG. 7 (to be described later). When the MFP 100 and the AP 101 are connected to each other in the wireless infrastructure mode, the AP 101 acquires information of whether the MFP 100 complies with IEEE 802.11v. If the AP 101 acquires information representing that the MFP 100 complies with IEEE 802.11v, the following processing is performed.

In S601, the AP 101 transmits, to the MFP 100, an inquiry (measurement requests) about the radio field intensities of APs around the MFP 100. This inquiry can be transmitted as, for example, a beacon frame request or a beacon report request. That is, this request can use a mechanism defined by the IEEE 802.11k standard.

In S602, in response to the request received in S601, the MFP 100 receives frames transmitted from the surrounding APs, and measures radio field intensities. Hence, the radio field intensities of the respective APs including the APs 101 and 102 are measured.

In S603, the MFP 100 transmits, as a response to the request received in S601, a list of the radio field intensities of the APs around the MFP 100 that have been measured in S602. Note that the radio field intensity as a response may be information saved in the RAM 214 or nonvolatile memory 215 of the MFP 100, in addition to or instead of the information measured in S602. This response is transmitted as, for example, a Beacon Report or measurement reports.

In S604, the AP 101 determines, based on the congestion status within a network grasped by the AP 101 and the radio field intensities received from the MFP 100 in S603, whether the connection destination of the MFP 100 needs to be changed. Factors with which the AP 101 determines that the connection destination needs to be changed are, for example, many STAs (the number of STAs is equal to or larger than a threshold) connected to the AP 101, a large communication amount (equal to or larger than a threshold) between the AP 101 and the STA connected to the AP 101, the presence/absence of an interference radio wave determined based on an SN ratio and the like, and the stop of the AP function. Based on the degree of congestion (the number of connected STAs and the communication amount) of each AP determined by using communication between the APs, it may be determined whether the connection destination needs to be changed. If it is determined that the connection destination of the MFP 100 needs to be changed, and the SSID, channel, and frequency band of another AP designated as the connection destination candidate of the MFP 100 after the change are decided, the process advances to S605. Note that in this embodiment, the SSID of another AP designated as the change destination of the connection destination is the same as the SSID of the AP as the change source.

In S605, the AP 101 transmits an AP change request (connection destination change request) to the MFP 100. The connection destination change request includes information of the SSID, MAC address, channel, and frequency band of another AP designated as the connection destination candidate after the change, which have been decided in S604. Note that a plurality of SSIDs may be designated. In this embodiment, assume that the APs between which the connection destination is switched by Wi-Fi Agile Multiband are set with the same SSID, and each AP can be identified by the MAC address. Therefore, another AP designated as the connection destination candidate after the change can be identified by the MAC address even if the SSID is the same as that of the AP as the change source. The connection destination change request is transmitted as, for example, a BTM Request. That is, a BSS Transition Management (BTM) Request frame defined by the IEEE 802.11v standard is transmitted. In the example of FIG. 6, assume that the AP 102 is designated as the connection destination candidate after the change included in the connection destination change request. That is, in this embodiment, the SSID of the AP 101 is the same as the SSID of the AP 102.

In S606, if the MFP 100 complies with the connection destination change request received in S605, it transmits, to the AP 101, a response representing approval of change. Alternatively, suppression processing of suppressing change of the connection destination AP (to be described later) may be performed. The response is transmitted as a BTM Response. In the example of FIG. 6, assume that a response representing approval is transmitted.

In S607, the AP 101 and the MFP 100 disconnect the connection in the wireless infrastructure mode. At this time, the MFP 100 holds the connection information to the AP 101 without deleting it.

In S608, the MFP 100 transmits a connection request to the AP 102 so as to be connected to the AP 102 designated by the connection destination change request received in S605.

In S609, therefore, connection between the MFP 100 and the AP 102 in the wireless infrastructure mode is established. After the connection between the MFP 100 and the AP 102 in the wireless infrastructure mode is established, the connection information to the AP 101 is deleted.

With this mechanism, the MFP 100 serving as an STA can change the connection destination from the AP 101 to the AP 102 based on the connection destination change request from the originally connected AP 101. The APs 101 and 102 may be APs installed in different places. That is, by the processing of FIG. 6, the MFP 100 can change the connection destination to another AP installed at a position different from that of the originally connected AP. APs sometimes correspond to different frequency bands among a plurality of frequency bands (two or three of 2.4-, 5-, and 6-GHz bands) provided by an identical apparatus. That is, by the processing of FIG. 6, the MFP 100 can change the frequency band to another frequency band provided by an apparatus identical to the originally connected AP. For example, the connection destination can be changed to a 6-GHz band AP based on the connection destination change request.

Note that in this embodiment, an example in which a measurement request and connection destination change request from an AP are transmitted by a mechanism complying with Wi-Fi Agile Multiband, and an STA responds to them, but the present invention is not limited to this. This embodiment is applicable to a case where an STA responds to a measurement request and connection destination change request transmitted from an AP using a mechanism different from the above-described example, and changes a connection destination AP (switching, deletion, or addition of an AP serving as a connection destination).

Depending on the state of the MFP 100 such as a job execution state, change of the connection destination AP based on the connection destination AP change request transmitted from the connected AP may not be preferable. In this embodiment, if change of the connection destination AP based on the change request is not preferable, one or a plurality of following suppressing processes may be performed in combination as processing of suppressing change of the connection destination according to the change request. Each of the following suppressing processes is processing of preventing the connection destination AP from being changed based on the change request or processing of making it difficult to change the connection destination AP.

(Suppression Processing 1) Even if the change request described in S605 is received, the connection destination AP is not changed based on the received connection request, a response to the change request is not returned, or a response representing rejection (a response representing that the connection destination AP is not changed) to the change request is transmitted to the connected AP. If the response representing rejection is transmitted, the priority level of the connection destination change of another STA connected to the AP connected to the MFP 100 is raised, the priority level of the connection destination change of the MFP 100 that has returned the response representing rejection is lowered, and thus it may be possible to maintain the connection to the connected AP. If no response is returned (the request is ignored), the connected AP maintains the connection to the MFP 100 in order to wait for a response until a time-out of the response standby time occurs. Therefore, in an arrangement in which connection is immediately disconnected when any response to the change request is received from the MFP 100, the time for maintaining the connection to the connected AP can be prolonged by returning no response, as compared with a case where any response is returned. Thus, for example, based on information of the reason for the change included in the change request, different processing may be performed depending on the reason such that a response representing rejection is sent for a weak reason and the request is ignored for a strong reason. The reason for the change can be determined based on information of any one of some reasons included in a Request Mode included in a BTM Request. For example, if a BSS Termination Included bit or a Disassociation Imminent bit of the Request Mode is 1, the change request can be determined as a change request whose reason for the change is a strong reason; otherwise, the reason for the change can be determined as a weak reason.

### (Suppression Processing 2)

Information indicating a radio wave condition (low signal quality) different from an actually measured condition is sent as a response (false response) to the measurement request described in S601 with respect to the radio wave reception condition (signal reception condition) of a non-connected AP other than the connected AP. In this case, a response may be sent by performing actual measurement in response to reception of the measurement request or a response may be sent without performing actual measurement. More specifically, in a response (beam report or the like) described in S603, with respect to signal quality measured as a signal received from the non-connected AP, a value with reduced received signal strength is sent as a response or/and a value with increased noise (signal-to-noise ratio) is sent as a response. Alternatively, contents excluding at least one piece of information of the non-connected AP may be sent as a response. Alternatively, based on information measured in the past with respect to the non-connected AP, a value with greatly lowered received signal strength or a value with greatly increased noise may be sent as a response. Alternatively, even if the measurement request is received, a response may be sent without including information of the non-connected AP by assuming the received signal strength and noise condition that are satisfactory only for the connected AP without performing actual measurement (AP search). The fact that a response to the measurement request is sent without including information of the non-connected AP corresponds to contents indicating that another non-connected AP is not discovered by an AP search. This can suppress the connection destination change request from being sent from the connected AP to another AP. Therefore, the connection destination is suppressed from being changed in accordance with the connection destination change request.

(Suppression Processing 3) The MFP 100 temporarily disconnects the connection from the connected AP, makes a notification of information representing that it does not comply with the change request, and is then reconnected to the same AP. More specifically, the MFP 100 temporarily disconnects the wireless connection from the connected AP, and creates, in preparation for performing wireless connection again, data of an Association Request frame including information representing that the MFP 100 does not comply with IEEE 802.11v. After that, connection processing to the AP is performed using the created data of the Association Request frame. As a result, if an Association Request frame including information representing that the MFP 100 does not comply with IEEE 802.11v is created, it is connected to the AP as an electronic apparatus not complying (incompatible) with the Agile Multiband function. As a result, the connected AP recognizes that the MFP 100 does not comply with IEEE 802.11v, and does not transmit the wireless connection destination change request to the MFP 100. In this way, since the MFP 100 is not requested to change the connection destination, the wireless connection between the MFP 100 and the connected AP is readily maintained. Furthermore, if the connected AP recognizes that the MFP 100 does not comply with IEEE 802.11v, transmission of the measurement request (the request described in S601) from the connected AP to the MFP 100 is also suppressed. Therefore, it is possible to suppress measurement (AP search) corresponding to the measurement request in the MFP 100 and a response (processing in S603) to the measurement request. It is possible to accordingly reduce the processing load and power consumption. In addition, resources can be used for another processing.

A state in which change of the connection destination AP based on the change request is not preferable includes, for example, a state in which print data is being received. The state in which the MFP 100 is receiving print data indicates, for example, a state in which part of print data of an image to be printed has already been received from the mobile terminal apparatus 104 serving as a counter apparatus, and reception of the remaining part of the print data is incomplete. Upon receiving part of the print data to be printed on one sheet, the MFP 100 prints the received print data (for example, receives print data of one line and prints it), and upon receiving subsequent data, prints this data. The MFP 100 repeats this processing, thereby executing printing. If the connection destination AP is changed based on the connection destination change request while receiving the print data, a time lag occurs along with the connection destination change processing, thereby lowering print quality like uneven printing. In addition, communication with the mobile terminal apparatus 104 serving as a counter apparatus may become poor after changing the connection destination, and subsequent data cannot be received, resulting in the failure of printing. Therefore, at least one of (Suppression Processing 1) and (Suppression Processing 2) described above may be performed as processing of suppressing the connection destination from being changed in accordance with the change request during reception of print data, or (Suppression Processing 3) described above may be performed before the start of reception of print data.

### (User Setting AP)

When a user operation of selecting/deciding an external AP as the connection destination of the MFP 100 is performed, the MFP 100 operating as an STA can be connected to the AP. An AP decided by a user operation will sometimes be referred to as a “user setting AP” hereinafter. The user setting AP is, for example, an AP that is set as the connection destination AP of the MFP 100 by operating the MFP 100, the mobile terminal apparatus 104, or the like by the user. In other words, the user setting AP is an AP to which the MFP 100 is connected before switching the connection destination by Wi-Fi Agile Multiband. Furthermore, in other words, the user setting AP is an AP different from the AP to which the MFP 100 is connected by switching the connection destination by Wi-Fi Agile Multiband. Switching of the connection destination by Wi-Fi Agile Multiband will be described later with reference to FIG. 6. Establishment of connection between the user setting AP and the MFP 100 will be described later with reference to FIG. 7. The user setting AP is, for example, a high-performance AP, an AP communicable in the 5-GHz frequency band, or the like.

When, for example, the MFP 100 is connected to the user setting AP, it may receive a connection destination AP change request from the user setting AP. In this specification, the connection destination AP change request will sometime be referred to as “change request” or “connection destination change request” hereinafter. Based on the change request, the MFP 100 controls to change the connection destination AP to another AP different from the user setting AP. In this way, when the connection destination AP is changed to another AP based on the change request, for example, the MFP 100 can be connected to the other AP even in a state in which the communication state of the user setting AP is congested.

On the other hand, for example, the MFP 100 can be kept connected to the other AP different from the user setting AP. That is, the MFP can be kept connected to the AP unintended by the user. Some ingenuity is therefore required to connect the MFP to a proper AP. Note that as an example, the user setting AP is assumed to be the above-described AP 101 in the following description.

In this embodiment, the MFP 100 is connected to the user setting AP 101. When the MFP 100 receives a connection destination change request from the connected AP 101, the MFP 100 controls to change the connection destination AP from the AP 101 to another AP different from the AP 101 in accordance with the change request. If the MFP 100 receives a connection destination change request from the other AP after being connected to the other AP, the MFP 100 controls to perform connection to the AP 101 of a list of recommended APs included in the change request. The list of recommended APs is a list of candidates of the connection destination AP. With this arrangement, even if the MFP 100 is connected to another AP different from the user setting AP, the MFP 100 can return the connection destination AP to the user setting AP.

The user setting AP will be described with reference to FIG. 7. FIG. 7 is a flowchart illustrating an example of processing of deciding an AP as the connection destination of the MFP 100. In this flowchart, the processing executed by the MFP 100 is implemented by reading out various programs stored in the memory such as the ROM 213 to the RAM 214 and executing them by the CPU 212. A case where the processing of FIG. 7 is executed based on, for example, acceptance of a predetermined operation of the operation display unit 220 by the user will be exemplified.

In this embodiment, before the start of the processing of FIG. 7, the same SSID is set in the APs 101 and 102. For example, since the APs 101 and 102 are APs complying with the Wi-Fi Agile Multiband function, the user sets the same SSID in the APs 101 and 102.

In step S701, the CPU 212 performs an AP search. The AP search is, for example, processing of searching for APs around the MFP 100. More specifically, the CPU 212 controls the wireless unit 226 to perform processing of searching for APs as connection destination candidates in an environment where the MFP 100 is installed. For example, the CPU 212 transmits an apparatus search request (Probe Request). After that, the CPU 212 receives an apparatus search response (Probe Response) transmitted from an AP or a Beacon (information spontaneously, periodically transmitted by an AP), thereby searching for APs around the MFP 100. In the AP search, information acquired from a surrounding AP includes, for example, at least one of the Service Set Identifier (SSID), the radio field intensity, frequency band, the Media Access Control address (MAC address), and information indicating the security method of the AP.

In step S702, the CPU 212 displays the result of the AP search on the operation display unit 220. For example, the CPU 212 displays, as the result of the AP search, a list of APs discovered around the MFP 100. For example, the CPU 212 may display a list of pieces of identification information of the discovered APs. The identification information is, for example, the SSID. Note that the identification information may be a device name or a MAC address. Furthermore, for example, the above-described list of pieces of identification information may be displayed as an interface that can accept a selection instruction from the user.

In step S703, the CPU 212 accepts a selection instruction of the connection destination AP of the MFP 100. More specifically, the CPU 212 accepts a selection instruction by the user from the result of the AP search displayed in step S702. For example, the above-described “user setting AP” is an AP for which a selection instruction by the user is accepted in this processing. In this embodiment, a case where the AP 101 is selected as the user setting AP will be exemplified. In step S703, the CPU 212 may display an interface that can accept input of authentication information such as a password of the user setting AP.

In step S704, the CPU 212 performs connection processing of performing connection to the user setting AP for which the selection instruction has been accepted in step S703. In step S704, when executing the connection processing, the CPU 212 stores connection information of the connection destination AP as connection information of the connected AP in the nonvolatile memory 215 or the like. In other words, the connection information of the connected AP is information indicating the AP connected last among the APs to which the MFP 100 has been connected before. A plurality of pieces of connection information of the connected destination APs may be stored. For example, a plurality of pieces of connection information of the APs to which the MFP 100 has been connected in the past may be stored in time series.

In step S705, the CPU 212 determines whether the result of the AP search in step S701 includes a plurality of APs having the same SSID as that of the user setting AP in step S703. If it is determined that a plurality of APs having the same SSID are included, the CPU 212 advances to step S706. On the other hand, if it is determined that there are no APs having the same SSID, the CPU 212 ends the processing of FIG. 7.

If the CPU 212 determines, in step S705, that there are no APs having the same SSID, it is regarded that a beacon frame request or a connection destination change request is not received from the AP 101. This is because it can be determined that there are no APs complying with the Wi-Fi Agile Multiband function around the MFP 100 and thus the connection destination AP is not changed by this function. That is, the connection destination AP of the MFP 100 is not changed to another AP different from the AP 101 based on the change request from the AP 101. Therefore, if NO is determined in step S705, the CPU 212 ends the processing of FIG. 7 without storing the connection information of the AP 101. On the other hand, if it is determined that there exist APs having the same SSID, it is determined that the user presets the same SSID in the APs complying with the Wi-Fi Agile Multiband function. Therefore, in this case, it is determined that a beacon frame request or a connection destination change request is received from the AP 101.

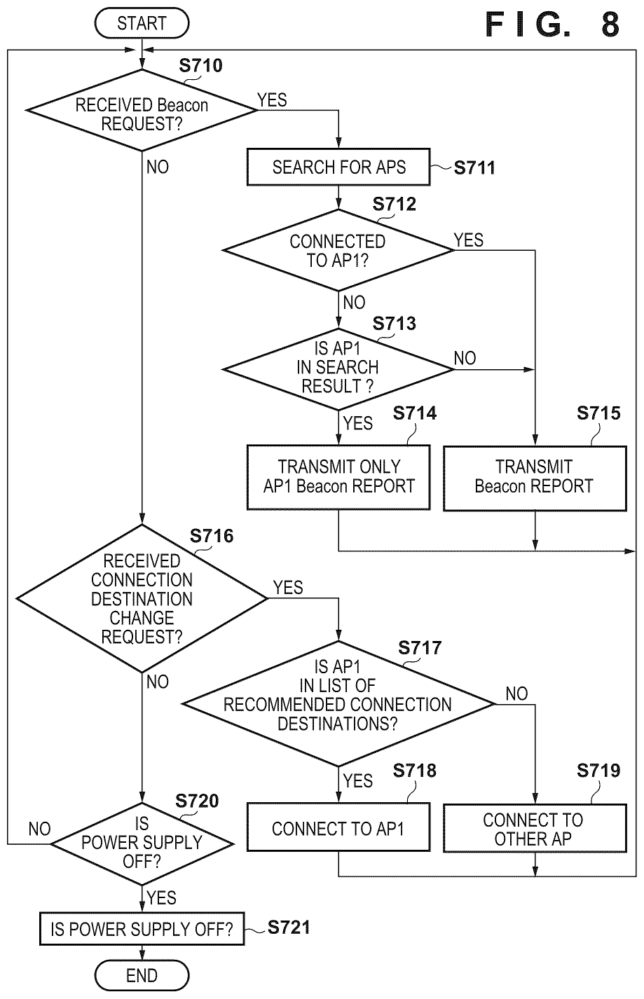

In step S706, the CPU 212 stores the connection information of the AP 101 as the user setting AP in the nonvolatile memory 215. The connection information is information used by the MFP 100 to perform connection to the AP. The connection information includes, for example, one or more of the SSID, the MAC address, the BSSID, and information indicating the security method, and the password. The connection information is used as, for example, information for determining whether the MFP 100 is being connected to the AP 101 (user setting AP) in processing of FIG. 8 to be described later or returning the connection destination to the original AP 101 after the connection destination AP is changed to another AP different from the AP 101. The connection information stored in step S706 is discriminated from the connection information stored in step S704. A storage area used in step S706 may be different from a storage are used in step S704, or the connection information may be discriminated by addition information such as a flag. The connection information stored in step S706, that is, the connection information of the user setting AP is kept held without being deleted even after the connection destination AP is changed by the Wi-Fi Agile Multiband function.

An example in which the user sets, on the panel (operation display unit 220) of the MFP 100, an external AP to be connected has been described above. However, a method of setting an external AP to which the MFP 100 is to be connected is not limited to the above example. An external AP to which the MFP 100 is to be connected may be set on a device other than the MFP 100. For example, an external AP to which the MFP 100 is to be connected may be set on the mobile terminal apparatus 104. Such example will be described below.

The mobile terminal apparatus 104 stores a program of network setup processing for transmitting the setting information of the AP to the MFP 100. The program of the network setup processing is an application program (setup application) for performing connection setting to the AP that connects the MFP 100, and may have another function other than a network setup function. For example, the setup application may have a function of causing the MFP 100 to execute printing, a function of causing the MFP 100 to scan a set document, a function of confirming the state of the MFP 100, and the like. The setup application may also have a function of transmitting, to a service management server (not shown), information acquired from the MFP 100, personal information of the user acquired by the mobile terminal apparatus 104, and the like. For example, the setup application is installed from an external server by Internet communication and internally stored. The setup application is, for example, an application program provided by the vendor of the MFP 100.

To perform the network setup processing, the MFP 100 operates in a network setup mode. The network setup mode of the MFP 100 will now be described.

The MFP 100 can operate in the network setup mode. A trigger for the MFP 100 to start an operation in the network setup mode may be, for example, the pressing of a network setup mode button by the user or activation (power-on) of the MFP 100 for the first time after arrival. The network setup mode button may be a hardware (physical) button of the MFP 100 or a software button displayed on the operation display unit 220 by the MFP 100.

When the MFP 100 starts an operation in the network setup mode, it enables Wi-Fi communication. More specifically, as Wi-Fi communication enabling processing, the MFP 100 enables an internal AP (setup AP) of the MFP 100 that is dedicated to the network setup mode. The SSID of the setup AP corresponds to the above-described unique SSID. Thus, the MFP 100 can establish Wi-Fi direct connection to the mobile terminal apparatus 104. Assume that connection information (SSID and password) for connection to the setup AP is held in advance in a setup application installed in the mobile terminal apparatus 104, and the MFP 100 recognizes in advance the connection information for connection to the setup AP. Therefore, unlike connection information of an AP enabled in a direct connection mode, the connection information for connection to the setup AP cannot be changed arbitrarily by the user. Note that in the network setup mode, the MFP 100 may be connected to the mobile terminal apparatus 104 by not normal Wi-Fi but Wi-Fi Direct (WFD). That is, the MFP 100 may operate as a group owner, and receive a setting command from the mobile terminal apparatus 104 by WFD communication. Alternatively, the MFP 100 may be connected to the mobile terminal apparatus 104 by Bluetooth in the network setup mode. Bluetooth includes Bluetooth Classic and Bluetooth Low Energy (BLE). That is, for example, the MFP 100 may operate as a slave apparatus in BLE in the network setup mode, and receive a setting command from the mobile terminal apparatus 104 by BLE communication. Furthermore, in the network setup mode, the MFP 100 may be able to execute both a network setup by Wi-Fi and a network setup by BLE. That is, when the MFP 100 starts an operation in the network setup mode, it may enable both Wi-Fi communication and BLE communication. More specifically, when the MFP 100 starts an operation in the network setup mode, it may enable both the setup AP and an advertising state in which BLE connection is enabled by transmitting advertising information by BLE. Furthermore, the MFP 100 may receive a setting command from the mobile terminal apparatus 104 by a wired LAN or USB.

As described above, the MFP 100 operates in the network setup mode for executing a network setup of the MFP 100 in accordance with a predetermined condition including the pressing of a button by the user and the initial installation timing. When the MFP 100 operates in the network setup mode, it controls the wireless unit 226 to operate as a setup AP that is enabled only during an operation in the network setup mode. The setup AP is an access point different from that enabled in the above-described software AP mode. Assume that the SSID of the setup AP includes a predetermined character string recognizable by the setting application of the mobile terminal apparatus 104.

Assume that the MFP 100 operating in the network setup mode uses a predetermined communication protocol (setup communication protocol) in communication with the mobile terminal apparatus 104 connected to the setup AP. More specifically, the setup communication protocol is, for example, Simple Network Management Protocol (SNMP).

If a predetermined time elapses after the MFP 100 starts an operation in the network setup mode, the MFP 100 stops the operation in the network setup mode and disables the setup AP. Furthermore, even when connection information for connection to an external AP and a change instruction of the wireless communication operation mode are received from the mobile terminal apparatus 104 in the network setup mode, the setup AP is disabled.

In this example, the mobile terminal apparatus 104 requests, of the MFP 100, a list of access points via Wi-Fi connection between the mobile terminal apparatus 104 and the MFP 100 operating in the network setup mode by the setup application. Upon receiving the request, the MFP 100 executes an AP search (execution of an AP search). The MFP 100 transmits a list of access points to the mobile terminal apparatus 104 via Wi-Fi connection. Note that the transmitted list is a list of one or a plurality of access points connectable to the MFP 100 and discovered by executing an AP search by the MFP 100. In this example, assume that the list includes the APs 101 and 102. The APs 101 and 102 are preset with the same SSID. The SSIDs and MAC addresses of the APs 101 and 102 are as follows.
AP 101: SSID-A, MAC-X
AP 102: SSID-A, MAC-Y

Then, the mobile terminal apparatus 104 displays the list including the APs 101 and 102 on the display unit 420. Since the SSIDs and MAC addresses are displayed on the list, the user can identify the AP (that is, the user setting AP) for which he/she requests the MFP 100 to perform setting. Assume that the user selects the AP 101 (SSID-A, MAC-X) (selection of the connection destination AP). The mobile terminal apparatus 104 transmits connection information of the AP 101 to the MFP 100. Note that the connection information may be transmitted by Bluetooth, wired LAN, USB, or the like instead of wireless direct connection. The connection information includes, for example, the SSID and MAC address of the access point selected from the list, and a password input by the user.

The MFP 100 recognizes, based on the result of the precedingly executed AP search, that the SSID selected by the user is one of the plurality of identical SSIDs. Then, the MFP 100 holds, as the connection information, the SSID-A (MAC-X) selected by the user (holding of connection information).

### (Processing of Changing Connection Destination AP of MFP 100)

An example of processing of changing the connection destination AP of the MFP 100 will be described next with reference to FIG. 8. For example, FIG. 8 is a flowchart for explaining an example of processing corresponding to a beacon frame request or a connection destination change request received by the MFP 100 from the connected AP. In this flowchart, processing executed by the MFP 100 is implemented by reading out various programs stored in the memory such as the ROM 213 to the RAM 214 and executing them by the CPU 212.

In step S710, the CPU 212 determines whether a beacon frame request is received from the connected AP. If the CPU 212 determines that a beacon frame request is received, the process advances to step S711. On the other hand, if it is determined that no beacon frame request is received, the process advances to step S716. The beacon frame request corresponds to an inquiry (measurement requests) about the radio field intensities of APs around the MFP 100, which has been described in S601. In other words, the beacon frame request is a request to search for APs around the MFP 100.

In step S711, the CPU 212 executes an AP search. Similar to step S701, the AP search is, for example, processing of searching for APs around the MFP 100.

In step S712, the CPU 212 determines whether the MFP 100 is being connected to the user setting AP. In this example, the user setting AP is the AP 101. If it is determined that the MFP 100 is not being connected to the user setting AP, the process advances to step S713. More specifically, for example, a case where it is determined that the MFP 100 is not being connected to the user setting AP is a case where the MFP 100 is being connected to an AP different from the user setting AP. More specifically, for example, a case where the MFP 100 is being connected to an AP different from the user setting AP is a case where the MFP 100 has switched the connection destination from the user setting AP to the AP 102 as an AP different from the user setting AP by the mechanism complying with Wi-Fi Agile Multiband, as described with reference to FIG. 6. On the other hand, if it is determined that the MFP 100 is being connected to the user setting AP, the process advances to step S715. More specifically, for example, a case where it is determined that the MFP 100 is being connected to the user setting AP is a case where even after the MFP 100 is connected to the user setting AP, the MFP 100 has not switched the connection destination by the mechanism complying with Wi-Fi Agile Multiband. Furthermore, the CPU 212 stores the connection information of the user setting AP, as described above. If the connection information of the connected AP is the connection information of the user setting AP, the CPU 212 may determine that the MFP 100 is being connected to the user setting AP. If the connection information of the connected AP is not the connection information of the user setting AP, it may be determined that the MFP 100 is not being connected to the user setting AP.

In step S713, the CPU 212 determines whether the result of the AP search in step S711 includes the user setting AP. If it is determined that the user setting AP is included, the CPU 212 advances to step S714. On the other hand, if it is determined that the user setting AP is not included, the CPU 212 advances to step S715. More specifically, the CPU 212 performs determination based on the connection information of the user setting AP stored in step S706. For example, the CPU 212 may determine whether the result of the AP search includes an AP with the same MAC address as that of the user setting AP in the connection information of the user setting AP. That is, if the result of the AP search includes an AP with the same MAC address as that of the user setting AP, the CPU 212 advances to step S714. On the other hand, if the result of the AP search does not include an AP with the same MAC address as that of the user setting AP or the connection information of the user setting AP is not stored in the MFP 100 (NO in step S705), the CPU 212 advances to step S715.

In step S714, the CPU 212 transmits (sends as a response) a beacon report including only the user setting AP to the connected AP (the transmission source of the beacon frame request). Note that in this processing, in addition to a case where the result of the AP search in step S711 includes only the user setting AP, even in a case where the result of the AP search in step S711 includes the user setting AP and another AP, a beacon report including only the user setting AP is transmitted. As described in S603, the beacon report is a list of radio field intensities. For example, the CPU 212 may select only the user setting AP from the result of the AP search executed in step S711, and transmit a beacon report including only the user setting AP. Alternatively, the CPU 212 may transmit a beacon report by excluding an AP different from the user setting AP from the result of the AP search. That is, step S714 can be said as processing of transmitting a beacon report indicating that the user setting AP is prioritized. Thus, it can be expected that a list of recommended (candidate) connection destination APs included in the connection destination change request from the connected AP includes the user setting AP. After step S714, the CPU 212 returns to step S710.

In step S715, the CPU 212 transmits, as a beacon report, the result of the AP search in step S711 to the connected AP. In this example, the CPU 212 transmits, to the connected AP, a beacon report including information of all the APs discovered by the AP search executed in step S711. That is, if the result of the AP search in step S711 includes the user setting AP and another AP, the CPU 212 transmits a beacon report including the user setting AP and the other AP. After step S715, the CPU 212 returns to step S710.

As described above, if a beacon frame request is received from the AP being connected to the MFP 100, the CPU 212 can make contents of the beacon report different based on the presence/absence of the user setting AP in the list.

In step S716, the CPU 212 determines whether a connection destination change request is received from the connected AP. The reception of the connection destination change request corresponds to S605 of FIG. 6. If it is determined that the connection destination change request is received, the CPU 212 advances to step S717. On the other hand, if it is determined that no connection destination change request is received, the CPU 212 advances to step S720.

In step S717, the CPU 212 determines whether the list of recommended connection destination APs included in the connection destination change request received from the connected AP includes AP1. If it is determined that AP1 is included, the CPU 212 advances to step S718. On the other hand, if it is determined that AP1 is not included, the CPU 212 advances to step S719. More specifically, the CPU 212 performs determination using the connection information of the user setting AP (AP 101) stored in step S706. For example, the CPU 212 determines whether the list of recommended connection destination APs includes an AP with the same MAC address as that of the user setting AP in the connection information of the user setting AP. Note that the list of recommended connection destination APs is a list of APs as connection destination candidates after the change, which has been described in S604 and S605. In this embodiment, as described above, if YES is determined in step S713, a beacon report including only the user setting AP is transmitted in step S714. If the beacon report including only the user setting AP is transmitted, the list of recommended connection destination APs includes only the user setting AP. Therefore, in this embodiment, if the beacon report including only the user setting AP is transmitted in step S714, the determination result in step S717 is YES.

In step S718, the CPU 212 performs connection to the user setting AP included in the list of recommended connection destination APs. At this time, the CPU 212 stores the connection information of the user setting AP as the connection information of the connected AP in the nonvolatile memory 215 in addition to the connection information stored in step S706.

In step S719, the CPU 212 performs connection to another AP different from the user setting AP. Furthermore, the CPU 212 stores connection information of the other AP as the connection information of the connected AP in the nonvolatile memory 215.

In step S720, the CPU 212 determines whether an instruction to turn off the MFP 100 is accepted. If it is determined that an instruction to turn off the MFP 100 is accepted, the CPU 212 advances to step S721. On the other hand, if it is determined that an instruction to turn off the MFP 100 is not accepted, the CPU 212 returns to step S710. The instruction to turn off the MFP 100 is, for example, an instruction based on a user operation of a power button (not shown) that can switch ON/OFF of the power of the MFP 100.

In step S721, the CPU 212 performs processing of disconnecting the connection between the MFP 100 and the AP, and ends the processing of FIG. 8.

As described above, according to this embodiment, if the MFP 100 receives a request to change to another AP from the user setting AP after performing connection to the user setting AP, it controls to change the connection destination AP from the user setting AP to the other AP. If the MFP 100 further receives a request to change the connection destination AP from the other AP, it controls to preferentially perform connection to the user setting AP among recommended APs included in the change request. With this operation, even if the MFP 100 changes the connection destination AP from the user setting AP to another AP, it can return the connection destination to the user setting AP. Thus, it is possible to suppress the connection destination AP of the MFP 100 from remaining connected to the other AP unintended by the user. That is, it is possible to connect the MFP 100 to a proper AP.

Note that in this embodiment, in steps S718 and S719, the CPU 212 executes processing of changing the connection destination AP but the present invention is not limited to this. For example, before the process advances to step S718 or S719 after the processing in step S717, the CPU 212 may determine whether the MFP 100 satisfies a predetermined condition. For example, if the MFP 100 does not satisfy the predetermined condition, the CPU 212 may skip the processing in step S718 or S719. That is, if the MFP 100 does not satisfy the predetermined condition, the CPU 212 may control not to execute the processing of changing the connection destination AP. In other words, if the MFP 100 does not satisfy the predetermined condition, the CPU 212 may control not to comply (to ignore) the connection destination change request.

Note that a state in which the predetermined condition is satisfied is a state in which the MFP 100 is suitable for change of the connection destination AP. A state in which the predetermined condition is not satisfied is a state in which the MFP 100 is not suitable for change of the connection destination AP. Examples of a case where the MFP 100 is not suitable for change of the connection destination AP are as follows:
(1) a case where the MFP 100 is reading a document
(2) a case where the MFP 100 is executing a job
(3) a case where the MFP 100 is communicating with an external information apparatus
(4) a case where if there is a constraint that the MFP 100 cannot operate in a case where a frequency band in which the MFP 100 operates as an AP is different from a frequency band in which the MFP 100 operates as an STA, the frequency band in which the MFP 100 operates an AP is different from the frequency band of the recommended connection destination AP included in the change request

As described above, even if the connection destination change request is received, when the MFP 100 does not satisfy the predetermined condition, the connection destination is not changed in step S718 or S719, thereby making it possible to suppress the influence on the processing being executed by the MFP 100.

### Second Embodiment

The second embodiment will be described below concerning points different from the first embodiment. The first embodiment has explained the form in which when a connection destination change request is received from a connected AP, the MFP 100 operates to change the connection destination to the AP 101 as a user setting AP. The second embodiment will describe a form in which even if the above-described connection destination change request is not received, when a predetermined condition is satisfied, an MFP 100 operates to change a connection destination AP to an AP 101 as a user setting AP.

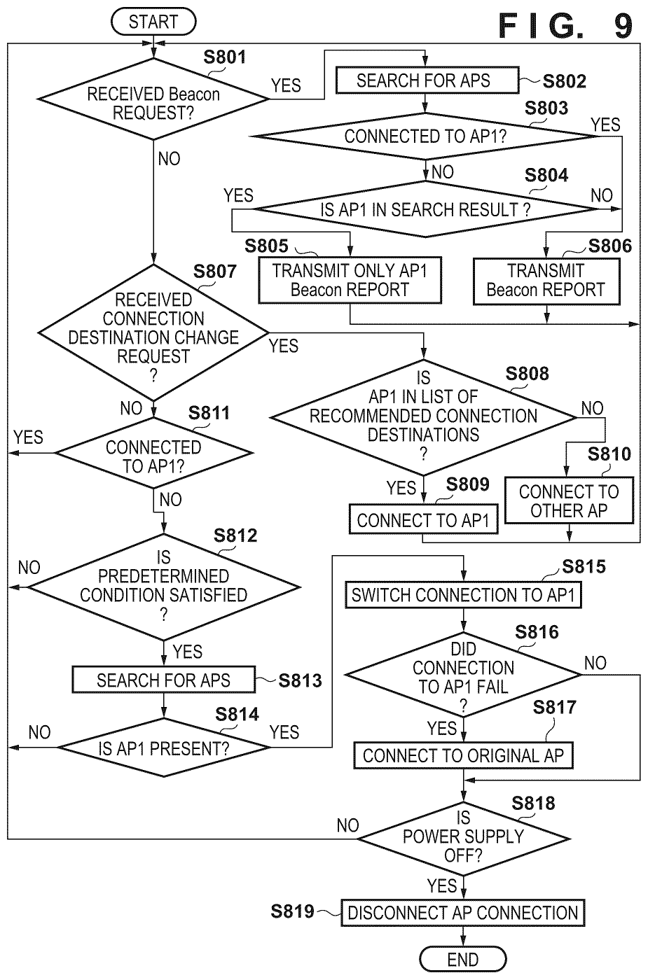

Processing executed by the MFP 100 according to this embodiment will be described with reference to FIG. 9. FIG. 9 is a flowchart for explaining examples of processing based on a beacon frame request, a connection destination change request, or the like received by the MFP 100 from a connected AP and processing based on the state of the MFP 100 according to this embodiment.

Note that processes in steps S801 to S806 and S808 to S810 of FIG. 9 are the same as those in steps S710 to S715 and S717 to S719 of FIG. 8 and a description thereof will be omitted.

In step S807, a CPU 212 determines whether a connection destination change request is received from the connected AP. The reception of the connection destination change request corresponds to S605 of FIG. 6. If it is determined that the connection destination change request is received, the CPU 212 advances to step S808. On the other hand, if it is determined that no connection destination change request is received, the CPU 212 advances to step S811.

In step S811, the CPU 212 determines whether the MFP 100 is being connected to the user setting AP. If it is determined that the MFP 100 is being connected to the user setting AP, the process advances to step S801. On the other hand, if it is determined that the MFP 100 is not being connected to the user setting AP, that is, the MFP 100 is being connected to another AP, the process advances to step S812. In this example, the user setting AP is the AP 101. More specifically, for example, the CPU 212 stores connection information of the user setting AP (AP 101) in step S706, as described above. If connection information of the connected AP is the connection information of the user setting AP, the CPU 212 may determine that the MFP 100 is being connected to the user setting AP.

In step S812, the CPU 212 determines whether a predetermined condition is satisfied. If it is determined that the predetermined condition is satisfied, the process advances to step S813. On the other hand, if it is determined that the predetermined condition is not satisfied, the process returns to step S801. The predetermined condition is a condition for the MFP 100 to change (return) the connection destination to the user setting AP. For example, when the following condition is satisfied, the CPU 212 determines that the predetermined condition is satisfied.

(1) A predetermined time elapses after the connection destination is changed from the AP 101 to another AP different from the AP 101.

(2) The MFP 100 is not executing a job. Note that the job includes a print job and a scan job.

(3) The MFP 100 is not executing printing.

(4) The MFP 100 is not reading a document.

(5) The MFP 100 is not communicating with an external information apparatus such as a DHCP server 103, a DNS server 105, or a mobile terminal apparatus 104.

(6) A predetermined time elapses in a state in which the MFP 100 is not busy and no user operation is performed. That is, the predetermined time elapses while the MFP 100 is in an idle state. Note that a state in which the MFP 100 is not busy is, for example, a state in which an instruction of a job like (2) is not received from the external information apparatus.

(7) The connection information of the user setting AP is stored in the MFP 100.

(8) A predetermined time elapses after change of the connection destination to the user setting AP fails.

(9) The MFP 100 is not operating as an AP (for example, the MFP 100 is not operating in the software AP mode). Alternatively, a frequency band in which the MFP 100 operates as an AP coincides with the frequency band of the connection destination AP (AP 101) after the change. In other words, the condition of (9) is that the frequency band in which the MFP 100 operates as an AP is not different from the frequency band of the connection destination AP (AP 101) after the change.

In this embodiment, (1) to (9) have been exemplified. If all of (1) to (9) are satisfied, it may be determined in step S812 that the predetermined condition is satisfied, or if at least one of (1) to (9) is satisfied, it may be determined that the predetermined condition is satisfied. The state of the MFP 100 other than (1) to (9) may be used as a determination criterion in step S812. In other words, determination in step S812 is determination of whether at least one of the state of the MFP 100 concerning the change of the connection destination AP and the state of the MFP 100 except for the change of the connection destination AP is a predetermined state.

In step S813, the CPU 212 executes an AP search. The AP search is, for example, processing of searching for APs around the MFP 100, similar to step S701.

In step S814, the CPU 212 determines whether the result of the AP search includes the user setting AP. If it is determined that the user setting AP is included, the process advance to step S815. On the other hand, if it is determined that the user setting AP is not included, the process returns to step S801. More specifically, for example, in determination in step S814, the CPU 212 compares the result of the AP search with the connection information of the AP 101 stored in step S706. For example, if the result of the AP search includes an AP with the same MAC address as that of the user setting AP, the CPU 212 advances to step S816.

In step S815, the CPU 212 controls to change the connection destination AP from the other AP to the user setting AP. More specifically, for example, the CPU 212 disconnects the connection from the connected AP. At this time, the connection information of the disconnected connected AP is temporarily, internally held until connection to the change destination AP succeeds. Thus, even if connection fails as a result of attempting to perform connection to the connection destination AP after the change, the CPU 212 can perform reconnection to the AP before the change, as will be described later, by temporarily storing the connection information of the connection destination AP before the change. Furthermore, it may be configured to store a plurality of pieces of connection information of connection destination APs. The CPU 212 performs connection processing of performing connection to the AP 101 using the connection information of the user setting AP (AP 101) stored in step S706.

In step S816, the CPU 212 determines whether connection to the user setting AP has failed. If it is determined that connection has not failed (has succeeded), the CPU 212 deletes the information indicating the connection destination AP before the change stored in step S815, and advances to step S818. On the other hand, if it is determined that connection has failed, the CPU 212 advances to step S817. For example, if the power of the user setting AP is OFF at this time or the MFP 100 is located at this time outside a range within which it is possible to perform communication with the user setting AP, connection to the user setting AP may fail.

In step S817, the CPU 212 performs connection processing of performing connection to the connection destination AP before the change using the connection information of the connection destination AP before the change stored in step S815. As described above, even if an attempt is made to change the connection destination AP of the MFP 100 to the user setting AP and then fails, the MFP 100 can be reconnected to the connection destination AP before the change.

In step S818, the CPU 212 determines whether an instruction to turn off the MFP 100 is accepted. If it is determined that an instruction to turn off the MFP 100 is accepted, the process advances to step S819. On the other hand, if it is determined that an instruction to turn off the MFP 100 is not accepted, the process advances to step S801. The instruction to turn off the MFP 100 is, for example, a user operation of a power button (not shown) that can switch ON/OFF of the power of the MFP 100.

In step S819, the CPU 212 performs processing of disconnecting the connection between the MFP 100 and the AP, and ends the processing of FIG. 9.

As described above, according to this embodiment, even if, in a state in which the MFP 100 is connected to another AP different from the user setting AP, the MFP 100 does not receive a connection destination change request from the other AP, if the MFP 100 satisfies the predetermined condition, the connection destination AP is returned to the user setting AP. This can suppress the MFP 100 from remaining connected to the other AP after the connection destination AP is changed from the user setting AP to the other AP based on the connection destination change request.

Note that various control operations described above that are performed by the CPU 212 may be performed by one hardware component, or control of the overall apparatus may be performed by sharing processing between a plurality of hardware components (for example, a plurality of processors or circuits).

In the above-described embodiments, an example in which the present invention is applied to the MFP has been described. However, the present invention is not limited to this example, and is applicable to any wireless apparatus that functions as an STA capable of performing processing corresponding to a connection destination change request from an AP, instead of the MFP. That is, the present invention is applicable to a personal computer, a PDA, a tablet terminal, a mobile phone terminal such as a smartphone, a music player, a game device, an electronic book reader, a smartwatch, and various measurement devices (sensor devices) such as a thermometer and a hygrometer. The present invention is applicable to digital cameras (including a still camera, a video camera, a network camera, and a security camera), a printer, a scanner, and a drone. The present invention is applicable to a video output device, an audio output device (for example, a smart speaker), a media streaming player, and a wireless LAN slave device (adaptor) capable of performing connection to a USB terminal or a LAN capable terminal. The video output device includes, for example, a device such as a set-top box, and acquires (downloads) a movie/still image on the Internet specified by a URL instructed from an electronic apparatus and outputs it to the display device connected via a video output terminal such as HDMI®. This implements streaming playback on the display device, and mirroring display (display in which contents displayed on the electronic apparatus are also displayed on the display device). The video output device also includes media players such as a television, a hard disk recorder, a Blu-ray recorder, and a DVD recorder, a head-mounted display, a projector, a television, a display device (monitor), and a signage device. The present invention is applicable to even Wi-Fi connectable devices called smart home appliances such as an air conditioner, a refrigerator, a washing machine, a cleaner, an oven, a microwave oven, lighting equipment, a heating appliance, and cooling equipment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-191129, filed Nov. 8, 2023, which is hereby incorporated by reference herein in its entirety.

What is claimed is:

1. An electronic apparatus communicable with an external access point, the electronic apparatus comprising at least one memory and at least one processor which function as:
a connection unit configured to establish connection between a first access point and the electronic apparatus;
a storage unit configured to store information concerning the first access point in a memory;
a first reception unit configured to receive, from the first access point, a first change request to request change of a connection destination of the electronic apparatus;
a first change unit configured to change, based on the reception of the first change request, the connection destination of the electronic apparatus to a second access point included in at least one access point corresponding to information included in the first change request;
a second reception unit configured to receive, from the second access point, a second change request to request change of the connection destination of the electronic apparatus after changing the connection destination of the electronic apparatus to the second access point;
a first determination unit configured to determine, based on the information concerning the first access point stored in the memory before the second change request is received, whether the first access point is included in at least one access point corresponding to information included in the second change request; and
a second change unit configured to change the connection destination of the electronic apparatus to the first access point based on determination that the first access point is included in the at least one access point corresponding to the information included in the second change request.

2. The apparatus according to claim 1,
wherein the at least one memory and the at least one processor further function as
a third change unit configured to change, based on determination that the first access point is not included in the at least one access point corresponding to the information included in the second change request, the connection destination of the electronic apparatus to a third access point included in a plurality of access points corresponding to the information included in the second change request.

3. The apparatus according to claim 1,
wherein the at least one memory and the at least one processor further function as
a third reception unit configured to receive, from the first access point, a first request to request information concerning at least one access point around the electronic apparatus, at a timing after changing the connection destination of the electronic apparatus to the second access point and before receiving the second change request,
a second determination unit configured to determine whether the first access point is included in at least one access point around the electronic apparatus discovered by a search executed by the electronic apparatus, and
a first control unit configured to control, based on a fact that the first access point is included in the at least one access point around the electronic apparatus discovered by the search executed by the electronic apparatus, to transmit the information concerning the first access point as a response to the first request and not to transmit information concerning an access point other than the first access point among the at least one access point around the electronic apparatus discovered by the search executed by the electronic apparatus,
wherein the second change request is transmitted to the electronic apparatus based on the response to the first request.

4. The apparatus according to claim 3,
wherein the at least one memory and the at least one processor further function as
a second control unit configured to control, based on a fact that the first access point is not included in the at least one access point around the electronic apparatus discovered by the search executed by the electronic apparatus, to transmit, as a response to the first request, information concerning the at least one access point around the electronic apparatus discovered by the search executed by the electronic apparatus.

5. The apparatus according to claim 3,
wherein the at least one memory and the at least one processor further function as
a fourth reception unit configured to receive a second request to request information concerning at least one access point around the electronic apparatus in a state in which connection between the first access point and the electronic apparatus is established, and
a second control unit configured to control to transmit, as a response to the second request, information concerning the at least one access point around the electronic apparatus discovered by the search executed by the electronic apparatus,
wherein the first change request is transmitted to the electronic apparatus based on the response to the second request.

6. The apparatus according to claim 1,
wherein the at least one memory and the at least one processor further function as
a fourth change unit configured to change, based on a lapse of a predetermined time after the connection destination of the electronic apparatus is changed to the second access point based on the reception of the first change request, the connection destination of the electronic apparatus to the first access point without receiving the second change request from the second access point.

7. The apparatus according to claim 6, wherein the connection destination of the electronic apparatus is changed to the first access point based on a fact that the predetermined time elapses after the connection destination of the electronic apparatus is changed to the second access point based on the reception of the first change request and the first access point is included in at least one access point around the electronic apparatus discovered by a search executed by the electronic apparatus.

8. The apparatus according to claim 1,
wherein the at least one memory and the at least one processor further function as
a fifth change unit configured to change the connection destination of the electronic apparatus to the first access point based on a fact that the connection destination of the electronic apparatus has been changed to the second access point based on the reception of the first change request and the electronic apparatus is not communicating with an external information apparatus.

9. The apparatus according to claim 8, wherein the connection destination of the electronic apparatus is changed to the first access point based on a fact that the connection destination of the electronic apparatus has been changed to the second access point based on the reception of the first change request, the electronic apparatus is not communicating with the external information apparatus, and the first access point is included in at least one access point around the electronic apparatus discovered by a search executed by the electronic apparatus.

10. The apparatus according to claim 1, further comprising a printer configured to execute printing,
wherein the at least one memory and the at least one processor further function as
a fifth change unit configured to change the connection destination of the electronic apparatus to the first access point based on a fact that the connection destination of the electronic apparatus has been changed to the second access point based on the reception of the first change request and the electronic apparatus is not executing the printing.

11. The apparatus according to claim 10, wherein the connection destination of the electronic apparatus is changed to the first access point based on a fact that the connection destination of the electronic apparatus has been changed to the second access point based on the reception of the first change request, the electronic apparatus is not executing the printing, and the first access point is included in at least one access point around the electronic apparatus discovered by a search executed by the electronic apparatus.

12. The apparatus according to claim 1, wherein the at least one memory and the at least one processor further function as:
a search unit configured to search for at least one access point around the electronic apparatus based on acceptance of a predetermined operation on the electronic apparatus from a user;
a display unit configured to display information of the at least one access point around the electronic apparatus discovered by the search executed by the electronic apparatus; and
an acceptance unit configured to accept, from the user, a selection operation of selecting one of the at least one access point around the electronic apparatus discovered by the search executed by the electronic apparatus,
wherein the first access point is the access point selected by the selection operation, and
connection between the first access point and the electronic apparatus is established based on the acceptance of the selection operation from the user.

13. The apparatus according to claim 1, wherein the at least one memory and the at least one processor further function as:
an information reception unit configured to receive, from an information processing apparatus outside the electronic apparatus, connection information for connection to any access point,
wherein the first access point is the access point corresponding to the connection information, and
connection between the first access point and the electronic apparatus is established based on the reception of the connection information.

14. The apparatus according to claim 13, wherein the at least one memory and the at least one processor further function as:
an information transmission unit configured to transmit, to the information processing apparatus, information of at least one access point around the electronic apparatus discovered by a search executed by the electronic apparatus,
wherein the access point corresponding to the connection information is an access point included in the at least one access point around the electronic apparatus discovered by the search executed by the electronic apparatus.

15. The apparatus according to claim 1, wherein change of the connection destination of the electronic apparatus executed based on the reception of the first change request is executed based on a Wi-Fi Agile Multiband function.

16. The apparatus according to claim 1, wherein the first access point and the second access point correspond to different frequency bands.

17. The apparatus according to claim 1, wherein connection between the first access point and the electronic apparatus can be established in a 6-GHz band.

18. The apparatus according to claim 1, wherein the at least one memory and the at least one processor further function as:
an execution unit configured to execute at least one of printing and scanning.

19. A control method of an electronic apparatus communicable with an external access point, the method comprising:
establishing connection between a first access point and the electronic apparatus;
storing information concerning the first access point in a memory;
receiving, from the first access point, a first change request to request change of a connection destination of the electronic apparatus;
changing, based on the reception of the first change request, the connection destination of the electronic apparatus to a second access point included in at least one access point corresponding to information included in the first change request;
receiving, from the second access point, a second change request to request change of the connection destination of the electronic apparatus after changing the connection destination of the electronic apparatus to the second access point;
determining, based on the information concerning the first access point stored in the memory before the second change request is received, whether the first access point is included in at least one access point corresponding to information included in the second change request; and
changing the connection destination of the electronic apparatus to the first access point based on determination that the first access point is included in the at least one access point corresponding to the information included in the second change request.

20. A non-transitory computer-readable storage medium storing computer-executable instructions that, when executed by a computer, cause the computer to:
establish connection between a first access point and an electronic apparatus;
store information concerning the first access point in a memory;
receive, from the first access point, a first change request to request change of a connection destination of the electronic apparatus;
change, based on the reception of the first change request, the connection destination of the electronic apparatus to a second access point included in at least one access point corresponding to information included in the first change request;
receive, from the second access point, a second change request to request change of the connection destination of the electronic apparatus after changing the connection destination of the electronic apparatus to the second access point;
determine, based on the information concerning the first access point stored in the memory before the second change request is received, whether the first access point is included in at least one access point corresponding to information included in the second change request; and
change the connection destination of the electronic apparatus to the first access point based on determination that the first access point is included in the at least one access point corresponding to the information included in the second change request.
